(19) United States
(12) Patent Application Publication
(10) Pub. No.: US 2008/0095363 A1
(43) Pub. Date: Apr. 24, 2008

(54) System and method for causing distortion in captured images

(76) Inventors: Jeffrey M. DiCarto, Palo Alto, CA (US); Nelson Liang An Chang, Palo Alto, CA (US); Niranjan Damera-Venkata, Palo Alto, CA (US); Simon Widdowson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/585,057

(22) Filed: Oct. 23, 2006

(51) Int. Cl. H04N 7/167

(52) U.S. Cl. 380/203

(57) ABSTRACT

An image display system including an image generator configured to generate display information for at least four display primaries by applying distortion information to an input signal, where the distortion information configured to compensate for variations in human cone responses, and a display device including the at least four display primaries and configured to display a first image with the at least four display primaries using the display information such that distortion from the distortion information appears in a second image captured by an image capture device to include the first image and such that substantially all human observers do not see the distortion in the first image is provided.

### CROSS-REFERENCE TO RELATED APPLICATION

This application is related to U.S. patent application Ser. No. 11/080,583, filed Mar. 15, 2005, and entitled PROJECTION OF OVERLAPPING SUB-FRAMES ONTO A SURFACE; and U.S. patent application Ser. No. 11/080,223, filed Mar. 15, 2005, and entitled PROJECTION OF OVERLAPPING SINGLE-COLOR SUB-FRAMES ONTO A SURFACE. These applications are incorporated by reference herein.

### BACKGROUND

Individuals often bring image capture devices to theaters to record current-run movies as they play on the screen and then produce illegal versions of the movies to sell. The illegal selling of movies may result in significant revenue loss for movie studios and theaters.

In addition, presenters of highly sensitive material (e.g., a corporate or military presentation) may wish to prevent the material from being captured by an image capture device.

It would be desirable to be able to prevent individuals from recording projected still or video images using image capture devices.

### SUMMARY

According to one exemplary embodiment, an image display system including an image generator configured to generate display information for at least four display primaries by applying distortion information to an input signal, where the distortion information configured to compensate for variations in human cone responses, and a display device including the at least four display primaries and configured to display a first image with the at least four display primaries using the display information such that distortion from the distortion information appears in a second image captured by an image capture device to include the first image and such that substantially all human observers do not see the distortion in the first image is provided.

### BRIEF DESCRIPTION OF THE DRAWINGS

FIG. 1 is a block diagram illustrating an image display system according to one embodiment of the present invention.

FIG. 2A is a graph illustrating human cone responses according to one embodiment of the present invention.

FIG. 2B is a graph illustrating camera sensor responses according to one embodiment of the present invention.

FIG. 3 is a block diagram illustrating a method for generating distortion information for use with an image display system according to one embodiment of the present invention.

FIGS. 4A-4B are flow charts illustrating a method for securely generating and displaying an image with an image display system according to one embodiment of the present invention.

FIG. 5 is a block diagram illustrating a projection system according to one embodiment of the present invention.

FIG. 6 is a block diagram illustrating a projection system according to one embodiment of the present invention.

FIGS. 7A-7D are diagrams illustrating the projection of four sub-frames according to one embodiment of the present invention.

FIGS. 8A-8B are diagrams illustrating sets of display primaries according to embodiments of the present invention.

FIG. 9 is a diagram illustrating a model of an image formation process according to one embodiment of the present invention.

FIG. 10 is a diagram illustrating sets of display primaries according to one embodiment of the present invention.

FIG. 11 is a diagram illustrating a model of an image formation process according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a system and method for causing distortion to appear in images captured by an image capture device (e.g., a still or video camera) to include displayed images is provided. The system and method display images by generating pixel values for the image that exploit the difference between the responses of a human observer and an image capture device. The system and method display images such that the images are perceived differently by human observers and image capture devices. As a result, the images appear as intended, i.e., normally, when viewed by a human observer but appear distorted when captured by an image capture device.

In one embodiment, the system and method display images using at least four display primaries. Using the display primaries, the system and method form selected pixels in the displayed image using combinations of the display primaries that appear the same to all or substantially all human observers but appear differently when captured by an image capture device. The system and method form the selected pixels using distortion information that accounts for human cone variations in all or substantially all human observers. As a result, all or substantially all human observers see the displayed images as intended while images captured by image capture devices to include the displayed images appear distorted when reproduced.

In another embodiment, a system and method display images by remapping pixel values to minimize any distortion seen by human observers and maximize the distortion captured by image capture devices. The system and method form selected pixels in the displayed image using distortion information that identifies color variations that are largely imperceptible to human observers but result in significant color differences in images captured by an image capture device. As a result, the system and method cause the display images to be seen by all or substantially all human observers with minimal distortion but captured by image capture devices with substantial distortion that appears when the captured images are reproduced.

The use of the embodiments described herein may prevent displayed images from being captured by an image capture device from being reproduced without distortion. Accordingly, the embodiments may enhance the security of displayed images to prevent unauthorized reproduction.

### I. Secure Image Display System and Methods

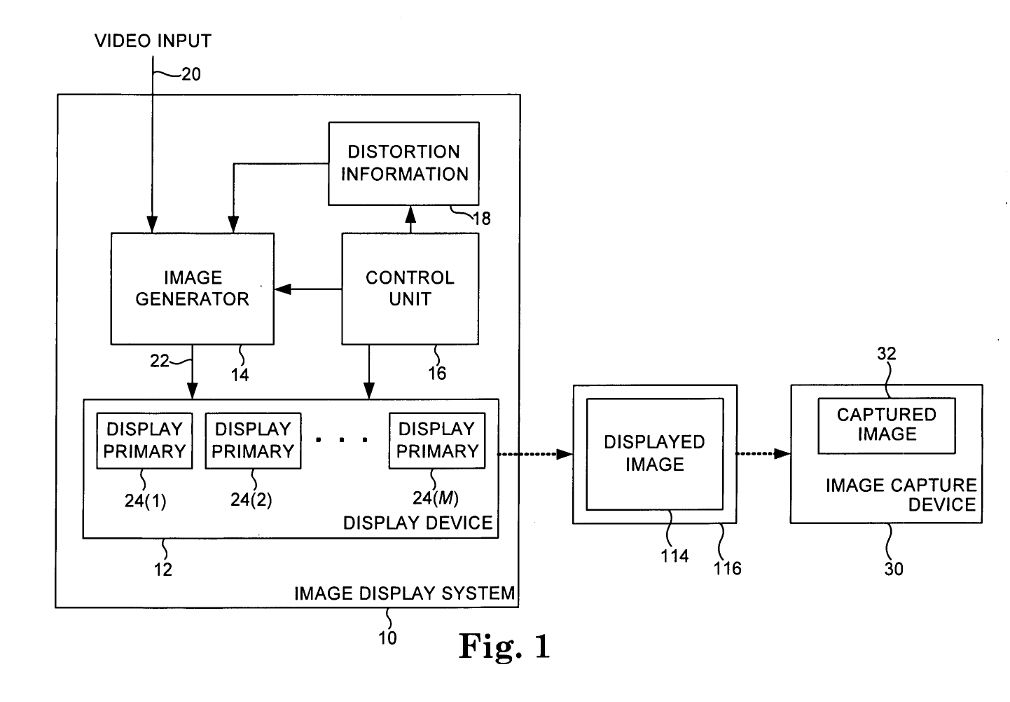

FIG. 1 is a block diagram illustrating one embodiment of an image display system 10. Image display system 10 includes a display device 12, an image generator 14, a control unit 16, and distortion information 18. Display device 12 includes display primaries 24(1) through 24(M) (referred to collectively as display primaries 24 or individually as a display primary 24). In one embodiment, M is greater than or equal to four. In another embodiment, M is less than four.

Image display system 10 projects a displayed image 114 into a display surface 116 using display device 12 in response to receiving a video input signal 20. Image display system 10 projects displayed image 114 such that displayed image 114 appears as intended (i.e., normally) when viewed by a human observer and displayed image 114 appears distorted when captured by an image capture device 30 (e.g., a still or video camera) as a captured image 32. To do so, image display system 10 projects at least a portion of image 114 to cause displayed image 114 to be perceived differently by a human observer than it is by image capture device 30. Because of these perceptual differences, captured image 32 is distorted relative to the perception of displayed image 114 of the human observer.

Image generator 14 receives video input signal 20 and distortion information 18. Video input signal 20 includes still or video image information in any suitable transmission and color format. In one embodiment, video input signal 20 includes an RGB video signal with red, green, and blue display primary components or channels. Distortion information 18 includes information that is used by image generator 14 to convert video input signal 20 to display information 22. Image generator 14 generates display information 22 from video input signal 20 and distortion information 18 and provides display information 22 to display device 12. Display information 22 is configured to cause displayed image 114 to appear normally when viewed by a human observer and appear distorted when captured by an image capture device 30 as captured image 32.

Display device 12 receives display information 22 from image generator 14 and displays displayed image 114 onto or in display surface 116. Display device 12 includes any suitable device or devices (e.g., a conventional projector, an LCD projector, a digital micromirror device (DMD) projector, a CRT display, an LCD display, or a DMD display) that are configured to display displayed image 114 onto or in display surface 116.

Control unit 16 provides control signals to display device 12, image generator 14, and distortion information 18 to cause display information 22 to be generated by image generator 14 and displayed by display device 12.

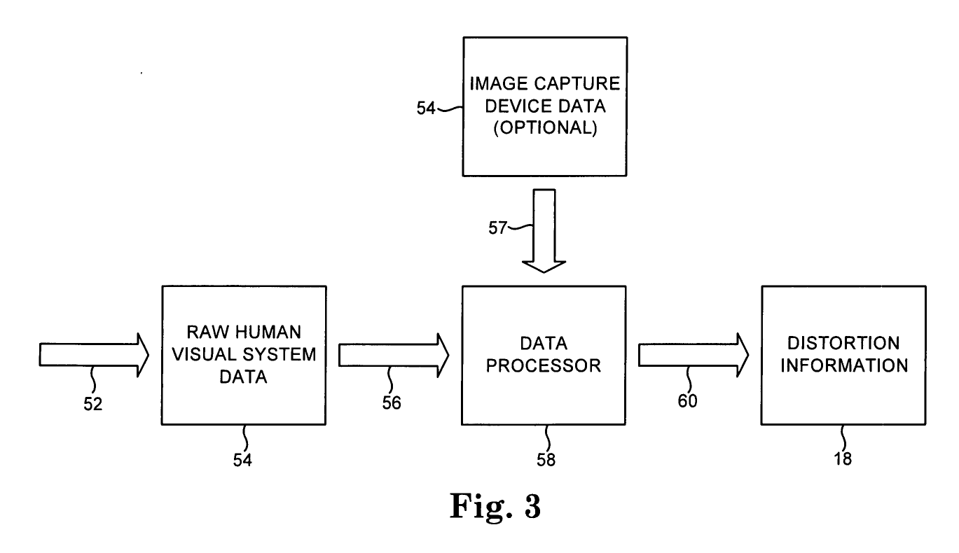

Distortion information 18 includes any suitable information for use by image generator 14 in converting video input signal 20 to display information 22. Distortion information 18 may be generated using the process described with reference to the embodiments of FIG. 3 below.

In the embodiment shown in FIG. 1, image generator 14, control unit 16, and distortion information 18 are separate from display device 12 in image display system 10. In other embodiments, one or more of image generator 14, control unit 16, and distortion information 18 may be included in or integrated with display device 12 in any suitable combination. In further embodiments, one or more of image generator 14, control unit 16, and distortion information 18 may be located remotely from display device 12. Accordingly, display information 22 may be transmitted from image generator 14 to display device 12 using any wired or wireless connection in this embodiment.

Image display system 10 is configured to exploit differences between how human observers and imaging devices, such as image capture device 30, capture an incident light signal. Equation A describes the transformation from an incident light signal to the human cone responses of a human observer, and Equation B describes the transformation from an incident light signal to the imaging device responses of image capture device 30. In the following Equations, P represents the spectral power distributions of the display primaries, w represents the intensities of the different display primaries, Rₕᵤₘₐₙ represents the human cone response functions of the human observer, R_{image} represents the camera sensor response functions of image capture device 30, and rₕᵤₘₐₙ and r_{image} represent the human cone and imaging device responses of the human observer and image capture device 30, respectively.

rₕᵤₘₐₙ=Rₕᵤₘₐₙ^{T}P w Equation A

r_{image} =R_{image}^{T}P w Equation B

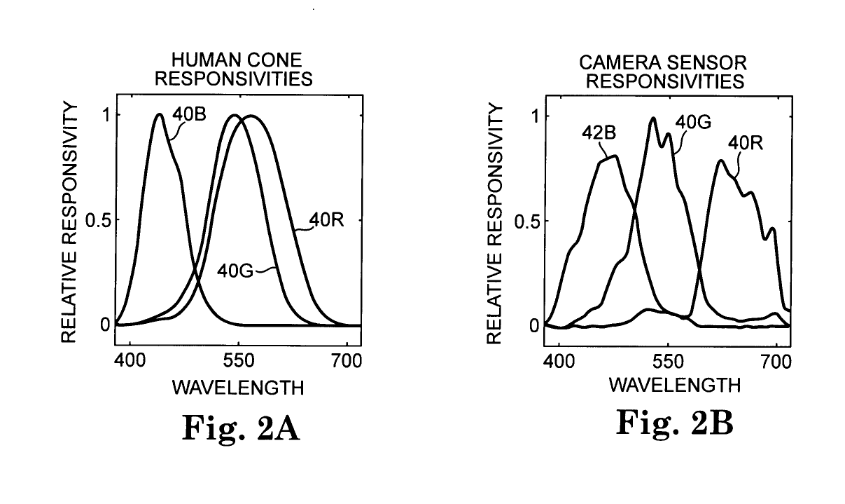

Generally speaking, Rₕᵤₘₐₙ and R_{image} in the above Equations are different as illustrated in FIGS. 2A and 2B. FIGS. 2A and 2B are graphs illustrating examples of human cone response functions of a human observer and camera sensor response functions of image capture device 30 for a range of wavelengths of light in the visible spectrum (i.e., approximately 400-700 nm).

In FIG. 2A, graphs 40B, 40G, and 40R approximate the human cone responses to blue, green, and red light, respectively. Similarly, graphs 42B, 42G, and 42R approximate the camera sensor responses to blue, green, and red light, respectively, in FIG. 2B. As may be seen, each graph 40B, 40G, and 40R differs from a respective graph 42B, 42G, and 42R. Accordingly, the human cone responses differ from the camera sensor responses for each of blue, green, and red light.

### A. Multi-Primary Image Display System and Method

As used here, the term multi-primary refers to image display systems with at least four display primaries where each display primary produces a different color of light.

In one embodiment, image display system 10 forms a multi-primary image display system with at least four display primaries 24 (i.e., M is greater than or equal to four). In this embodiment, image generator 14 receives video input signal 20 and generates display information 22 using distortion information 18 such that display information 22 includes at least four display primary signal components or channels (e.g., a red component, a green component, a blue component, and a yellow component) for driving respective display primaries 24 of display device 12. Display device 12 receives display information 22 from image generator 14 and displays displayed image 114 onto or in display surface 116 using at least four display primaries 24.

In this embodiment, image display system 10 forms selected pixels in the displayed image using combinations of display primaries 24 that appear the same to all or substantially all human observers but appear differently when captured by image capture device 30. Image display system 10 forms the selected pixels using distortion information 18 that accounts for human cone variations in all or substantially all human observers.

As an example, assume that image display system 10 includes four display primaries 24(1) through 24(4) and is displaying a neutral gray color to a human observer. Thus, where display primaries 24(1) through 24(3) are red, green, and blue primaries, and display primary 24(4) is a display primary color other than red, green, or blue, for example, w^{gray}=[0.5 0.5 0.5 0]. The human cone responses of the human observer to the neutral gray color, rₕᵤₘₐₙ^{gray}, are as indicated in Equation C.

rₕᵤₘₐₙ^{gray}=Rₕᵤₘₐₙ^{T}P w^{gray}

Equation C

Because image display system 10 includes at least four display primaries 24, there exists a set of primary intensities, w^{null}α, that for any α, will produce the same visual gray color when viewed by a human observer as illustrated in Equation D.

rₕᵤₘₐₙ^{gray}=Rₕᵤₘₐₙ^{T}P w^{gray}+Rₕᵤₘₐₙ^{T}P w^{null}α Equation D

If the same values of w^{null}α, are included in the transformation for image capture device 30 (i.e., Equation B), the imaging device responses of image capture device 30 become dependent on the value of α as shown in Equation E.

r_{image}^{gray}+r_{image}^{null}=R_{image}^{T}P w^{gray}+R_{image}^{T}P w^{null}α Equation E

Accordingly, any change in the value of α will produce a different imaging device response of image capture device 30.

By changing the value of α spatially, temporally, or a combination of spatially and temporally, a human observer sees the same color, but image capture device 30 potentially captures different colors for each different value of α. As a result, displayed image 114 appears normally when viewed by a human observer and appears distorted when captured by an image capture device 30.

Image display system 10 attempts to maximize the difference in the responses of a human observer and image capture device 30 while preventing any human observer from seeing any distortion in displayed image 114. To do so, image display system 10 forms selected pixels in displayed image 114 using combinations of the display primaries that appear the same to all or substantially all human observers but appear differently when captured by an image capture device. Image display system 10 forms the selected pixels using distortion information 18 where, in this embodiment, distortion information 18 accounts for human cone variations in all or substantially all human observers. As a result, all or substantially all human observers see display images 114 as intended while images 32 captured by image capture device 30 appear distorted when reproduced.

To prevent all or substantially all human observers from seeing any distortion in displayed images 114, distortion information 18 is derived from a database or another set of information that accounts for the human cone response variations in all or substantially all human observers in this embodiment. Accordingly, distortion information 18 compensates for human cone response variations in all or substantially all human observers. Distortion information 18 identifies combinations of color values of display primaries 24 that allow all or substantially all human observers to see an identical color.

FIG. 3 is a block diagram illustrating a method for generating distortion information 18 for use with image display system 10 according to one embodiment. In FIG. 3, a database 54 of raw human visual system data is created as indicated by an arrow 52.

Database 54 includes sufficient information to describe the human cone responses of all or substantially all human observers. In particular, database 54 includes sufficient information to describe the variations in the short, medium, and long human cone responses of all or substantially all human observers. Database 54 may be experimentally derived by testing the human cone responses of a large sample of human observers and measuring the responses. Database 54 may also be accessed from existing human cone response data that includes a large sample of human observers such as from medical or scientific journals.

Once database 54 is compiled, a data processor 58 analyzes database 54, as indicated by an arrow 56, to extract distortion information 18 from database 54, as indicated by an arrow 60.

In one embodiment, database 54 forms a set of N matrices, where N is an integer number of human observers that is sufficiently large to describe the variations in the short, medium, and long human cone responses of all or substantially all human observers. Each matrix is a 101×3 matrix where the columns define the human cone response functions of the short, medium, and long cone responses of a human observer, respectively, over a range of visible wavelengths of light (e.g., 400-700 nm). Accordingly, database 54 may be represented by a 101×(3N) matrix which will be referred to as matrix G.

To extract distortion information 18 from the 101×(3N) matrix of database 54, data processor 58 runs single value decomposition (SVD), QR decomposition, or another suitable decomposition algorithm on the 101×(3N) matrix.

In one embodiment, data processor 58 runs SVD on matrix G. By running SVD on matrix G, for example, data processor 58 decomposes matrix G into matrices U, S, and V^{T} as shown in Equation F.

G_{101×(3N)}=U_{101×101}S_{101×3N}V^{T}_{3N×3N} Equation F

In matrix S, all matrix elements are zero except those along the diagonal (i.e., the singular values). Data processor 58 extracts the first P columns of U to form a 101×P matrix H. In one embodiment, P is an integer that is less than the number M of display primaries 24. In another embodiment, P is an integer equal to the number of singular values of S that are non-zero or above a threshold. The threshold may be set to be equal to a knee point in a plot of the singular values of S, where the x-axis represents the singular value column numbers in S and the y-axis represents the magnitude of the singular values in S, or may be set according to any other suitable criteria.

Data processor 58 transposes matrix H into a P×101 matrix and multiplies by the spectral power distributions of the display primaries 24 of display device 12 to generate a P×(P+Q) matrix J. The spectral power distributions may be represented by a 101×(P+Q) matrix, where the term P+Q is equal to the number of display primaries 24 in display device 12 and where each column represents one of the display primaries 24. By running SVD on matrix J, for example, data processor 58 decomposes matrix J into matrices U, S, and V^{T} as shown in Equation G.

J_{P×(P+Q)}=U_{P×P}S_{P×(P+Q)}V^{T}_{(P+Q)×(P+Q)} Equation G

In matrix S, the (P+1)th to (P+Q)th singular values are equal to zero. Thus, data processor 58 extracts the last Q columns of V^{T} into a (P+Q)×Q matrix wₙᵤₗₗ (shown in Equations D and E above), wherein wₙᵤₗₗ forms distortion information 18 in one embodiment.

In other embodiments, data processor 58 extracts distortion information 18 from database 54 in any other suitable way.

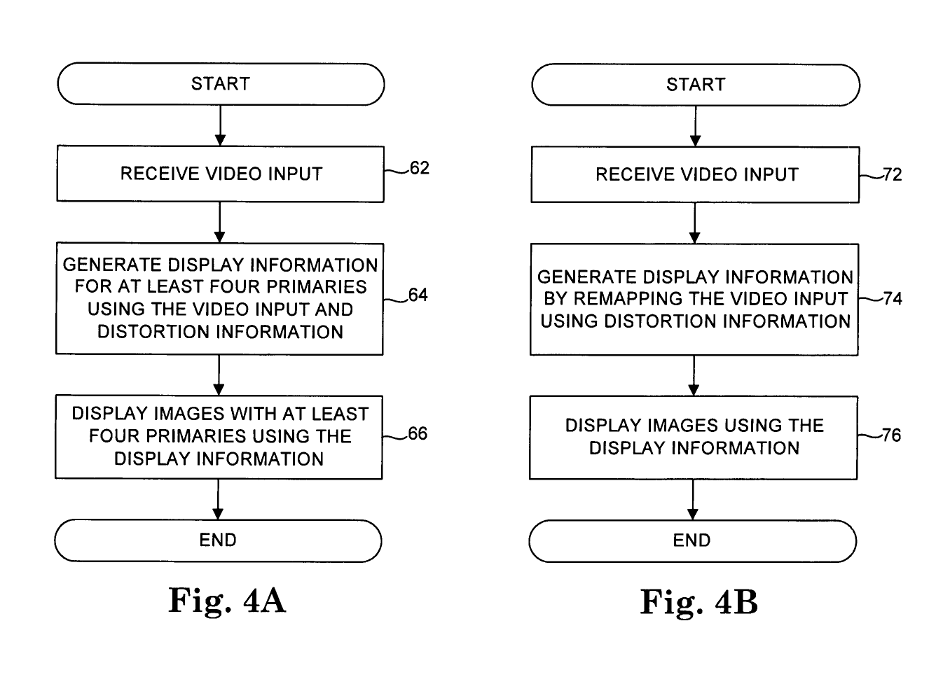

FIG. 4A is a flow chart illustrating a method for securely generating and displaying image 114 with image display system 10 according to one embodiment.

Referring to FIGS. 1 and 4A, image generator 14 receives video input signal 20 as indicated in a block 62. Image generator 14 generates display information 22 for at least four primaries using video input signal 20 and distortion information 18 as indicated in a block 64. Display information 22 may include an image frame for each image frame received from video input signal 20.

In one embodiment wherein wₙᵤₗₗ forms distortion information 18, image generator 14 generates display information 22 to include a set of pixel values, D, for each pixel location in an image frame according to Equation H.

D=w+w^{null}α Equation H

In Equation H, w is a (P+Q)×1 matrix where the each row includes an a respective color input value from input signal 20 for a pixel location in an image frame. Row matrix elements in w associated display primaries 24 that are not provided by input signal 20 may be set to zero. α is a Q×1 matrix that includes a set of gain factors used to apply distortion information 18 (i.e., w^{null}), and D is a matrix that includes a pixel value for each display primary 24. Each gain factor in α may be selected to ensure that each pixel value in D remains within a valid range of color values. Thus, image generator 14 forms the set of pixel values for each pixel location in display information 22 using Equation H in one embodiment to maximize a perceptual difference between displayed image 114 on display surface 116 and captured image 32 captured by image capture device 30 to include displayed image 114 while compensating for human cone response variations.

Image generator 14 may apply distortion information 18 to sets of pixel values in all or selected (i.e., less than all) pixel locations spatially (i.e., at various spatial locations in a displayed image 114), temporally (i.e., at spatial locations in successive displayed images 114), or a combination of spatially and temporally. Accordingly, distortion may appear in captured images 32 that include displayed image 114 spatially, temporally, or both spatially and temporally.

Display device 12 displays displayed images 114 with at least four display primaries 24 using display information 22 as indicated in a block 66.

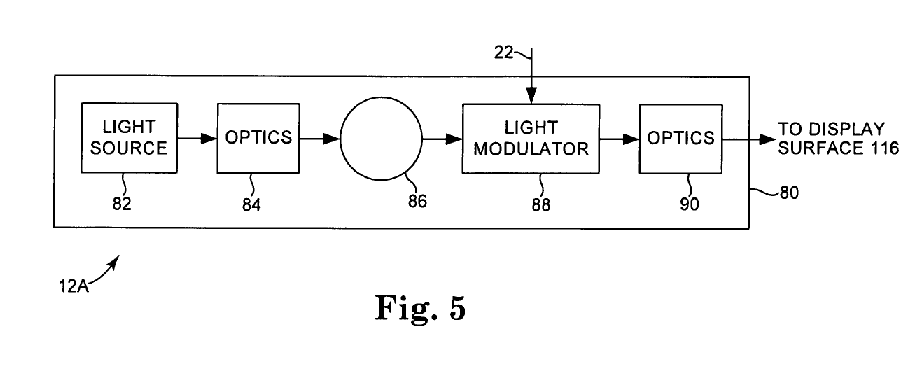

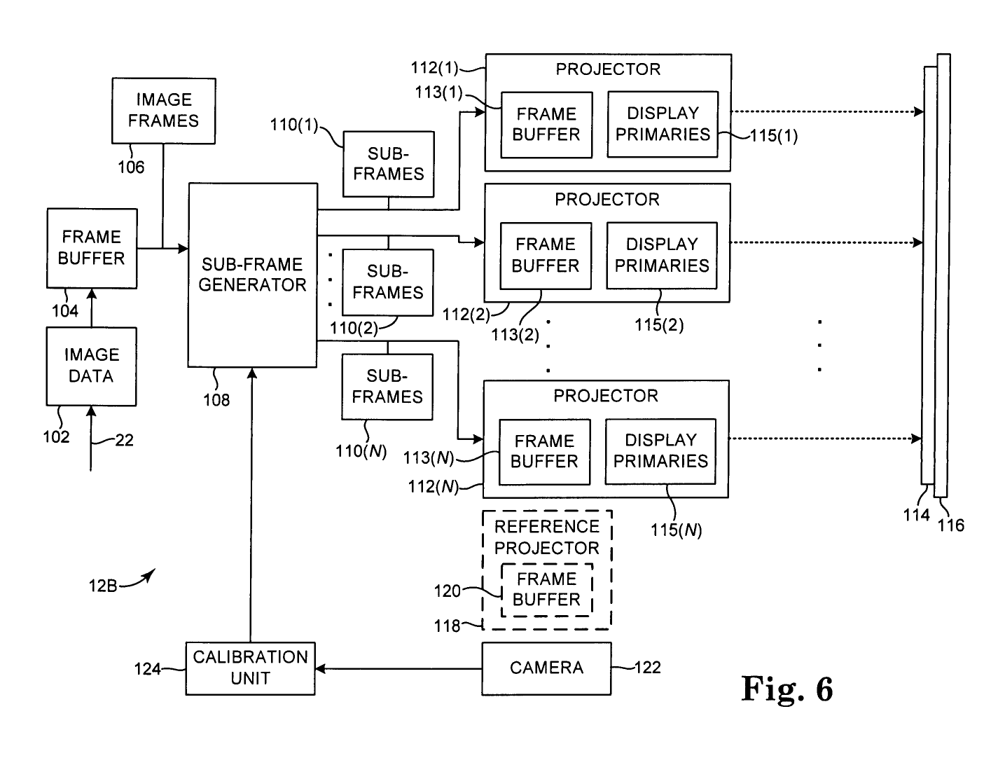

A multi-primary image display system according to the embodiment just described may be implemented in a single display device system, as illustrated with reference to FIG. 5 below, or in a multiple projector system, as illustrated with reference to FIG. 6 below.

The derivation of distortion information 18 from a database 54 with information that compensates for variations in human cone responses ensures that all or substantially all human observers will not see the distortion that appears in captured images 32 of image capture device 30. In systems that do not compensate for variations in human cone responses in all or substantially all human observers, such as systems that are based the CIE standard observer, at least some human observers will likely see the added distortions (e.g., color variations) in displayed images.

### B. Standard Primary Image Display System and Method

As used here, the term standard primary image display system refers to an image display system with fewer than four display primaries where each display primary produces a different color of light.

In one embodiment, image display system 10 forms a standard primary image display system with fewer than four display primaries 24 (i.e., M is less than four). In this embodiment, image generator 14 receives video input signal 20 and generates display information 22 using distortion information 18 such that display information 22 includes display primary signal components or channels for driving respective display primaries 24 of display device 12. Display device 12 receives display information 22 from image generator 14 and displays displayed image 114 onto or in display surface 116 using at least four display primaries 24.

In one embodiment, image displays system 10 displays images 114 by remapping pixel values to minimize any distortion seen by human observers and maximize the distortion captured by image capture device 30. Image displays system 10 forms selected pixels in the displayed image using distortion information 18 that identifies color variations that are largely imperceptible to human observers but result in significant color differences in images 32 captured by image capture device 30. As a result, image displays system 10 causes the display images 114 to be seen by all or substantially all human observers with minimal distortion but captured by image capture device 30 with substantial distortion that appears when captured images 32 are reproduced.

Image display system 10 attempts to maximize the difference in the responses of a human observer and image capture device 30 while minimizing any distortion seen by a human observer in displayed image 114. To do so, image display system 10 uses distortion information 18 that is derived from human color perception and camera color perception measurements so that distortion information 18 may be used to identify color values that appear similar to human observers but different to image capture device 30.

In another embodiment of the method of FIG. 3, database 54 of raw human visual system data is created, as indicated by arrow 52, by measuring human observer responses to a range of colors. Database 54 may be created by projecting side-by-side color differences for human observers to score. Database 54 includes sufficient information to allow colors that appear similar to human observers to be identified.

In addition, a database 55 of image captured device data of one or more image capture devices 30 is created by measuring the image capture devices responses to a range of colors. Database 55 may be created by projecting a series of color patterns to map out the color gamut of one or more image capture devices 30. Database 55 includes sufficient information to allow sets of similar colors that appear differently to one or more image capture devices 30 to be identified.

Once databases 54 and 55 are compiled, data processor 58 analyzes databases 54 and 55, as indicated by arrow 56 and an arrow 57, to compile distortion information 18 from database 54, as indicated by arrow 60. To do so, data processor 58 identifies the sets of colors in an appropriate color space (e.g., Lab) whose image capture device responses are maximally distinct and human observer responses are minimally distinct (e.g., below a selected threshold). In one embodiment, data processor 58 generates distortion information 18 as a remapping table that identifies colors that are similar to human observers and maximally distinct to one or more image capture devices 30.

FIG. 4B is a flow chart illustrating a method for securely generating and displaying image 114 with image display system 10 according to one embodiment.

Referring to FIGS. 1 and 4B, image generator 14 receives video input signal 20 as indicated in a block 72. Image generator 14 generates display information 22 by remapping video input signal 20 with distortion information 18 as indicated in a block 74. In one embodiment, image generator 14 accesses a remapping table in distortion information 18 and remaps pixel values in all or selected (i.e., less than all) pixel locations of an image frame formed from video input signal 20.

In one embodiment, image generator 14 remaps all colors in an image frame using distortion information 18 with colors that are similar to human observers and maximally distinct to one or more image capture devices 30. In another embodiment, image generator 14 analyzes image frames to identify regions of similar color and remaps the identified regions with colors that are similar to human observers and maximally distinct to one or more image capture devices 30.

Image generator 14 may apply distortion information 18 to all or selected pixel locations spatially (i.e., at various spatial locations in a displayed image 114), temporally (i.e., at spatial locations in successive displayed images 114), or a combination of spatially and temporally. Accordingly, distortion may appear in captured images 32 of image capture device 30 spatially, temporally, or both spatially and temporally.

Display device 12 displays displayed images 114 using display information 22 as indicated in a block 76.

By remapping pixel values using distortion information 18, image generator 14 maximizes the difference in the responses of a human observer and image capture device 30 while minimizing any distortion seen by a human observer in displayed image 114.

### II. Single Display Device Image Display System

As illustrated in the embodiment described with reference to FIG. 5, an embodiment 12A of display device 12 includes a single projector 80. Projector 80 has an optical path that includes a light source 82, optics 84, a color wheel 86, a light modulator 88, and optics 90.

Light source 82 provides an illumination beam through optics 84 and color wheel 86. Color wheel 86 filters the illumination beam using the display primaries to provide different primary colors at different times onto light modulator 88. Light modulator 88 selectively reflects or refracts the illumination beam from color wheel 86, according to display information 22, to transmit light through optics 90 and onto display surface 116.

In other embodiments, projector 80 of display device 12A may be replaced with another type of display device such as an LCD or DMD projector or an LCD, DMD or conventional display.

A. Multi-Primary Image Display System

With multi-primary image display systems 10 (described in Section I(A) above), color wheel 86 includes at least four display primaries 24 configured to project at least four display primary colors according to one embodiment.

In one embodiment, color wheel 86 includes red, green, blue, and yellow display primaries 24. In other embodiments, color wheel 86 may include any other combination of four or more display primaries 24. In further embodiments, color wheel 86 may be replaced with any other suitable light filtering device configured to produce four or more display primaries 24.

In other embodiments, projector 80 in display device 12A may be replaced with another type of display device such as an LCD or DMD projector or an LCD, DMD or conventional display with at least four display primaries 24 configured to project at least four display primary colors.

B. Standard Primary Image Display System

With standard primary image display systems 10 (described in Section I(B) above), color wheel 86 includes three or fewer display primaries 24 configured to project three or fewer display primary colors according to one embodiment.

In one embodiment, color wheel 86 includes red, green, and blue display primaries 24. In other embodiments, color wheel 86 may include any other combination of three or fewer display primaries 24. In further embodiments, color wheel 86 may be replaced with any other suitable light filtering device configured to produce three display primaries 24.

In other embodiments, projector 80 of display device 12A may be replaced with another type of display device such as an LCD or DMD projector or an LCD, DMD or conventional display with three or fewer display primaries 24 configured to project three or fewer display primary colors.

### III. Multiple Projector Image Display System

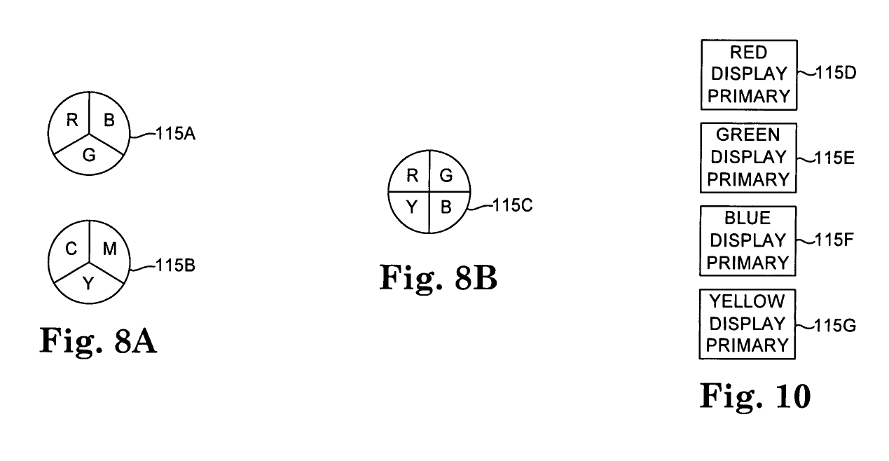

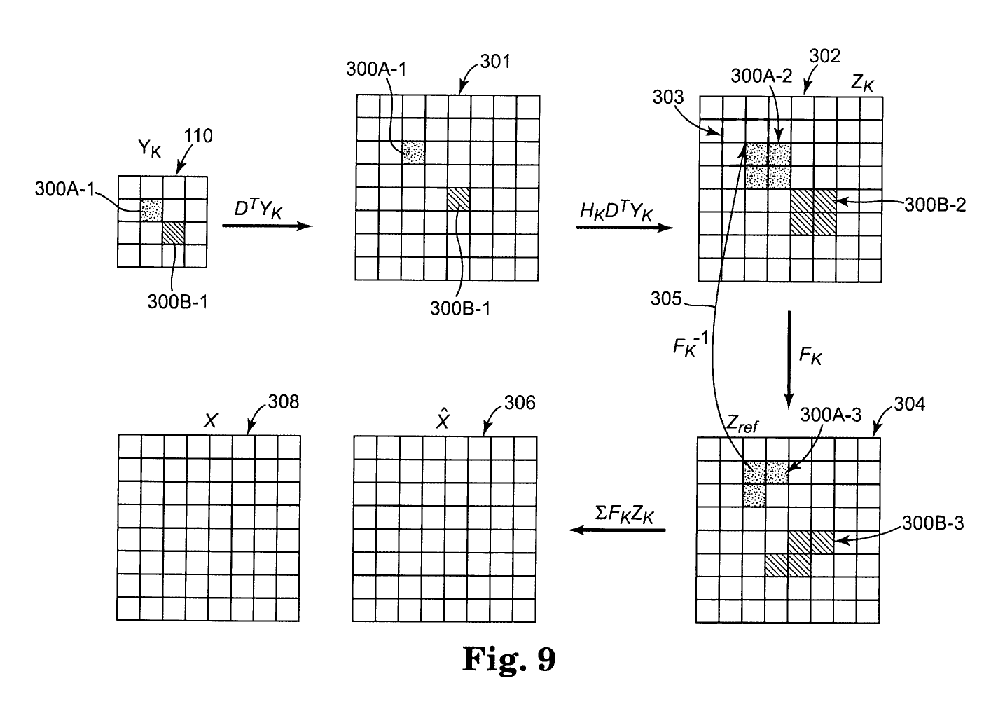

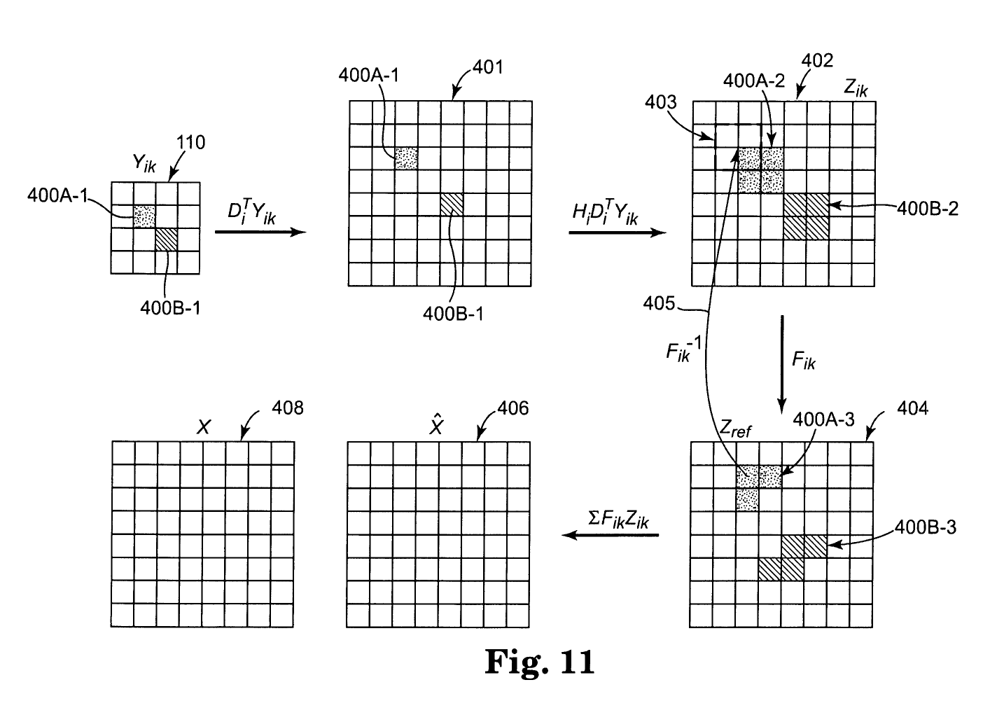

As illustrated in the embodiments described with reference to FIGS. 6-11, an embodiment 12B of display device 12 (shown in FIG. 6) includes multiple projectors 112 and will be referred to as projection system 12B. In embodiments illustrated and described with reference to FIGS. 8A, 8B, and 9, at least one of projectors 112 may be configured to display multiple colors. In other embodiments illustrated and described with reference to FIGS. 10 and 11, projectors 112 may each be configured to display a single color.

Projection system 12B processes image data 102 and generates corresponding displayed image 114. Image data 102 includes display information 22 as generated by image generator 14 (shown in FIG. 1) as indicated by an arrow 22. Displayed image 114 is defined to include any pictorial, graphical, or textural characters, symbols, illustrations, or other representations of information.

Projection system 12 includes image frame buffer 104, sub-frame generator 108, projectors 112(1)-112(N) where N is greater than or equal to two (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110(1)-110(N) (collectively referred to as sub-frames 110). For each image frame 106, sub-frame generator 108 generates one sub-frame 110 for each projector 112. Sub-frames 110-110(N) are received by projectors 112-112(N), respectively, and stored in image frame buffers 113-113(N) (collectively referred to as image frame buffers 113), respectively. Projectors 112(1)-112(N) project the sub-frames 110(1)-110(N), respectively, onto display surface 116 to produce displayed image 114 for viewing by a user.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106. Sub-frame generator 108 may generates sub-frames 110 to fully or partially overlap in any suitable tiled and/or superimposed arrangement on display surface 116.

Projectors 112 receive image sub-frames 110 from sub-frame generator 108 and, in one embodiment, simultaneously project the image sub-frames 110 onto target 116 at overlapping and spatially offset positions to produce displayed image 114. In one embodiment, projection system 12B is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

Projectors 112(1)-112(N) each include a set of one or more display primaries 115(1)-115(N), respectively. Each projector 112 projects sub-frames 110 using the set of display primaries 115 for that projector.

Sub-frame generator 108 determines appropriate values for the sub-frames 110 so that the displayed image 114 produced by the projected sub-frames 110 is close in appearance to how the high-resolution image (e.g., image frame 106) from which the sub-frames 110 were derived would appear if displayed directly.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

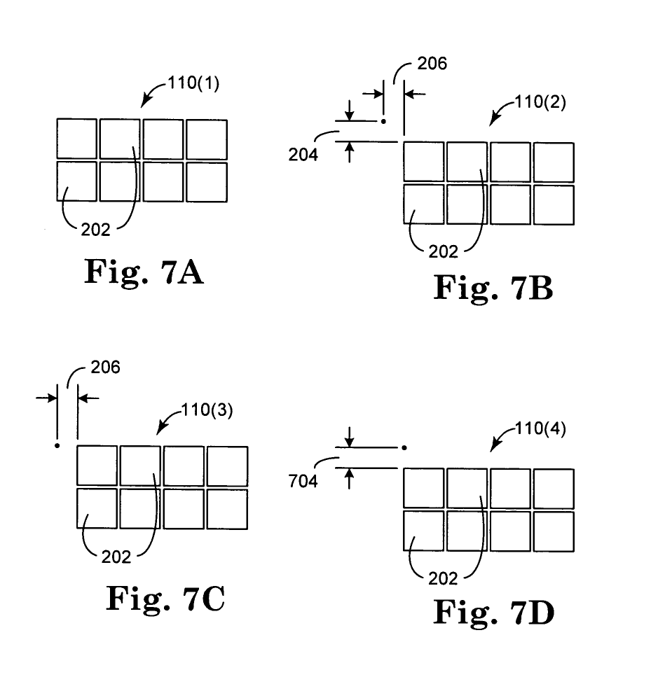

Also shown in FIG. 6 is reference projector 118 with an image frame buffer 120. Reference projector 118 is shown with hidden lines in FIG. 6 because, in one embodiment, projector 118 is not an actual projector, but rather is a hypothetical high-resolution reference projector that is used in an image formation model for generating optimal sub-frames 110, as described in further detail below with reference to FIGS. 7A-7D, the embodiments of FIGS. 8A, 8B, and 9, and the embodiment of FIGS. 10 and 11. In one embodiment, the location of one of the actual projectors 112 is defined to be the location of the reference projector 118.

In one embodiment, projection system 12B includes the at least one camera 122 and a calibration unit 124, which are used in one form of the invention to automatically determine a geometric mapping between each projector 112 and the reference projector 118, as described in further detail below with reference to FIGS. 7A-7D, the embodiments of FIGS. 8A, 8B, and 9, and the embodiment of FIGS. 10 and 11. For each point in display surface 116, calibration unit 124 may be configured to compensate for any color variations captured by camera 122 as a result of the distortion information 18 added to display information 22 by image generator 14 (FIG. 1).

In one form of the invention, projection system 12B includes hardware, software, firmware, or a combination of these. In one embodiment, one or more components of projection system 12B are included in a computer, computer server, or other microprocessor-based system capable of performing a sequence of logic operations. In addition, processing can be distributed throughout the system with individual portions being implemented in separate system components, such as in a networked or multiple computing unit environment.

FIGS. 7A-7D are schematic diagrams illustrating the projection of four sub-frames 110(1), 110(2), 110(3), and 110(4). In this embodiment, projection system 12B includes four projectors 112, and sub-frame generator 108 generates at least a set of four sub-frames 110(1), 110(2), 110(3), and 110(4) for each image frame 106 for display by projectors 112. As such, sub-frames 110(1), 110(2), 110(3), and 110(4) each include a plurality of columns and a plurality of rows of individual pixels 202 of image data.

FIG. 7A illustrates the display of sub-frame 110(1) by a first projector 112(1). As illustrated in FIG. 7B, a second projector 112(2) displays sub-frame 110(2) offset from sub-frame 110(1) by a vertical distance 204 and a horizontal distance 206. As illustrated in FIG. 7C, a third projector 112(3) displays sub-frame 110(3) offset from sub-frame 110(1) by horizontal distance 206. A fourth projector 112(4) displays sub-frame 110(4) offset from sub-frame 110(1) by vertical distance 204 as illustrated in FIG. 7D.

Sub-frame 110(1) is spatially offset from sub-frame 110(2) by a predetermined distance. Similarly, sub-frame 110(3) is spatially offset from sub-frame 110(4) by a predetermined distance. In one illustrative embodiment, vertical distance 204 and horizontal distance 206 are each approximately one-half of one pixel.

The display of sub-frames 110(2), 110(3), and 110(4) are spatially shifted relative to the display of sub-frame 110(1) by vertical distance 204, horizontal distance 206, or a combination of vertical distance 204 and horizontal distance 206. As such, pixels 202 of sub-frames 110(1), 110(2), 110(3), and 110(4) at least partially overlap thereby producing the appearance of higher resolution pixels. Sub-frames 110(1), 110(2), 110(3), and 110(4) may be superimposed on one another (i.e., fully or substantially fully overlap), may be tiled (i.e., partially overlap at or near the edges), or may be a combination of superimposed and tiled. The overlapped sub-frames 110(1), 110(2), 110(3), and 110(4) also produce a brighter overall image than any of sub-frames 110(1), 110(2), 110(3), or 110(4) alone.

In other embodiments, other numbers of projectors 112 are used in system 12B and other numbers of sub-frames 110 are generated for each image frame 106.

In other embodiments, sub-frames 110(1), 110(2), 110(3), and 110(4) may be displayed at other spatial offsets relative to one another and the spatial offsets may vary over time.

In one embodiment, sub-frames 110 have a lower resolution than image frames 106. Thus, sub-frames 110 are also referred to herein as low-resolution images or sub-frames 110, and image frames 106 are also referred to herein as high-resolution images or frames 106. The terms low resolution and high resolution are used herein in a comparative fashion, and are not limited to any particular minimum or maximum number of pixels.

In one embodiment, projection system 12B produces a superimposed projected output that takes advantage of natural pixel mis-registration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected. In one embodiment described in additional detail with reference to FIG. 11 below, the signal processing model is used to derive values for the sub-frames 110 that minimize visual color artifacts that can occur due to offset projection of single-color sub-frames 110.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to the embodiments of FIG. 9 and FIG. 11.

One form of the embodiment of FIG. 11 determines and generates single-color sub-frames 110 for each projector 112 that minimize color aliasing due to offset projection. This process may be thought of as inverse de-mosaicking. A de-mosaicking process seeks to synthesize a high-resolution, full color image free of color aliasing given color samples taken at relative offsets. One form of the embodiment of FIG. 11 essentially performs the inverse of this process and determines the colorant values to be projected at relative offsets, given a full color high-resolution image 106.

A. Multiple Color Projectors

In one embodiment, at least one projector 112 in projection system 12B projects multiple colors, i.e., two or more colors.

i. Multi-Primary Image Display Systems

With multi-primary image display systems 10 (described in Section I(A) above), the combination of all projectors 112 in projection system 12B display at least four different display primaries 24. Projectors 112 may include different sets of display primaries 115, as illustrated in the embodiment of FIG. 8A, or may include the same set of display primaries 115, as illustrated in the embodiment of FIG. 8B.

FIG. 8A is a diagram illustrating two sets of display primaries 115A and 115B according to one embodiment. Set 115A includes red, green, and blue display primaries 24, and set 115B includes cyan, magenta, and yellow display primaries 24. Sets 115A and 115B may each be implemented as color wheels or any other suitable light filtering devices in projectors 112.

In one embodiment, projectors 112(1)-112(i) each include set 115A and projectors 112(i+1)-112(N) each include set 115B, where i is any integer between 1 and (N−1) inclusive. In this embodiment, projection system 12B is divided into two subsets of projectors 112 where the subsets combine to project six display primaries: red, green, blue, cyan, magenta, and yellow.

In other embodiments, each set of display primaries may include other numbers and combinations of display primaries. In addition, projectors 112 may be further divided into additional subsets where each subset of projectors 112 includes a different set of display primaries and each set of display primaries differs from the other sets of display primaries.

FIG. 8B is a diagram illustrating one set of display primaries 115C according to one embodiment. Set 115C includes red, green, blue, and yellow display primaries 24. Set 115C may be implemented as a color wheel or any other suitable light filtering devices in projectors 112. In the embodiment of FIG. 8B, projectors 112(1)-112(N) each include set 115C. In this embodiment, projectors 112 each project four display primaries: red, green, blue, and yellow.

In other embodiments, the set of display primaries in each projector 112 may include other numbers and combinations of display primaries.

For the embodiment of FIGS. 8A and 8B, sub-frame generator 108 (FIG. 6) generates sub-frames 110 with the combination of colors for each set of projectors 112 as described below with reference to FIG. 9.

ii. Standard Primary Image Display Systems

With standard primary image display systems 10, (described in Section I(B) above), all projectors 112 in projection system 12B typically display the same display primaries (e.g., red, green, and blue primaries). Thus, each set of display primaries 115 includes the same set of three display primaries in one embodiment. Sub-frame generator 108 (FIG. 6) generates sub-frames 110 with the colors for each projector 112 as described below with reference to FIG. 9.

In one embodiment, image generator 14 applies distortion information 18 to video input 20 prior to sub-frame generator 108 generating sub-frames 110. In other embodiments (not shown), sub-frame generator 108 applies distortion information 18 in the process of generating sub-frames 110 to remap the pixel values of sub-frames 110.

iii. Sub-Frame Generation for Multiple Color Projectors

FIG. 9 is a diagram illustrating a model of an image formation process according to one embodiment of the present invention. The sub-frames 110 are represented in the model by Yₖ, where “k” is an index for identifying the individual projectors 112. Thus, Yₗ, for example, corresponds to a sub-frame 110(1) for a first projector 112(1), Y₂ corresponds to a sub-frame 110(2) for a second projector 112(2), etc. Two of the sixteen pixels of the sub-frame 110 shown in FIG. 9 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I
where:
   k=index for identifying the projectors 112;
   Zₖ=low-resolution sub-frame 110 of the kth projector 112 on a hypothetical high-resolution grid;
   Hₖ=Interpolating filter for low-resolution sub-frame 110 from kth projector 112;
   D^{T}=up-sampling matrix; and
   Yₖ=low-resolution sub-frame 110 of the kth projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 9, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 3003B-2 in the high-resolution image 302 (Zₖ). The resulting image 302 (Zₖ) in Equation I models the output of the k^{th} projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to the frame buffer 120 of the reference projector 118 (FIG. 6) with sub-pixel accuracy, to generate a warped image 304 (Z_{ref}). In one embodiment, Fₖ is linear with respect to pixel intensities, but is non-linear with respect to the coordinate transformations. As shown in FIG. 9, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one form of the present invention, during the forward mapping (Fₖ), the inverse mapping (Fₖ^{-l}) is also utilized as indicated at 305 in FIG. 9. Each destination pixel in image 304 is back projected (i.e., Fₖ^{-l}) to find the corresponding location in image 302. For the embodiment shown in FIG. 9, the location in image 302 corresponding to the upper-left pixel of the pixels 300A-3 in image 304 is the location at the upper-left corner of the group of pixels 300A-2. In one form of the invention, the values for the pixels neighboring the identified location in image 302 are combined (e.g., averaged) to form the value for the corresponding pixel in image 304. Thus, for the example shown in FIG. 9, the value for the upper-left pixel in the group of pixels 300A-3 in image 304 is determined by averaging the values for the four pixels within the frame 303 in image 302.

In another embodiment of the invention, the forward geometric mapping or warp (Fₖ) is implemented directly, and the inverse mapping (Fₖ^{-l}) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (X-hat) in the reference projector frame buffer 120, as represented in the following Equation II:

$$\hat{X} = {\sum }_{k} {F}_{k} {Z}_{k} \qquad Equation II$$

where:
   k=index for identifying the projectors 112;
   X-hat=hypothetical or simulated high-resolution image 306 in the reference projector frame buffer 120;
   Fₖ=operator that maps a low-resolution sub-frame 110 of the kth projector 112 on a hypothetical high-resolution grid to the reference projector frame buffer 120; and
   Zₖ=low-resolution sub-frame 110 of kth projector 112 on a hypothetical high-resolution grid, as defined in Equation I.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 6) received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III
where:
   X=desired high-resolution frame 308;
   X-hat=hypothetical or simulated high-resolution frame 306 in the reference projector frame buffer 120; and
   η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation IV:

$${Y}_{k}^{*} = {arg max}_{{Y}_{k}} P ( \hat{X} \vert X ) \qquad Equation IV$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308; and
   P(X-hat|X)=probability of X-hat given X

Thus, as indicated by Equation IV, the goal of the optimization is to determine the sub-frame values (Yₖ) that maximize the probability of X-hat given X. Given a desired high-resolution image 308 (X) to be projected, sub-frame generator 108 (FIG. 6) determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
   X-hat=hypothetical or simulated high-resolution frame 306 in the reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{{‖ X - \hat{X} ‖}^{2}}{2 {σ}^{2}}} \qquad Equation VI$$

where:
   X-hat=hypothetical or simulated high-resolution frame 306 in the reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {arg min}_{{Y}_{k}} {‖ X - \hat{X} ‖}^{2} + {β}^{2} {‖ ∇ \hat{X} ‖}^{2} \qquad Equation IX$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308;
   βsmoothing constant; and
   ∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁺¹⁾=Yₖ⁽ⁿ⁾−Θ{DHₖF_{K}^{T}└(\hat{X}⁽ⁿ⁾−X)+β²∇²\hat{X}⁽ⁿ⁾┘} Equation X
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ);
   X-hat⁽ⁿ⁾=hypothetical or simulated high-resolution frame 306 in the reference projector frame buffer 120, as defined in Equation II, for iteration number n;
   X=desired high-resolution frame 308;
   β=smoothing constant; and
   ∇²=Laplacian operator.

Equation X may be intuitively understood as an iterative process of computing an error in the reference projector 118 coordinate system and projecting it back onto the sub-frame data. In one embodiment, sub-frame generator 108 (FIG. 6) is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for the sub-frames 110 is determined. In one embodiment, the initial guess for the sub-frames 110 is determined by texture mapping the desired high-resolution frame 308 onto the sub-frames 110. In one form of the invention, the initial guess is determined from the following Equation XI:

Yₖ⁽⁰⁾=DBₖFₖ^{T}X Equation XI
where:
   k=index for identifying the projectors 112;
   Yₖ⁽⁰⁾=initial guess at the sub-frame data for the sub-frame 110 for the kth projector 112;
   D=down-sampling matrix;
   Bₖ=interpolation filter;
   Fₖ^{T}=Transpose of operator, Fₖ, from Equation II (in the image domain, Fₖ^{T} is the inverse of the warp denoted by Fₖ); and
   X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another form of the invention, the initial guess, Yₖ⁽⁰⁾, for the sub-frames 110 is determined from the following Equation XII

Yₖ⁽⁰⁾=DFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix;
   Fₖ^{T}=Transpose of operator, Fₖ, from Equation II (in the image domain, Fₖ^{T} is the inverse of the warp denoted by Fₖ); and
   X=desired high-resolution frame 308.

Equation XII is the same as Equation XI, except that the interpolation filter (Bₖ) is not used.

Several techniques are available to determine the geometric mapping (Fₖ) between each projector 112 and the reference projector 118, including manually establishing the mappings, or using camera 122 and calibration unit 124 (FIG. 6) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a projection system 12B with two projectors 112(1) and 112(2), assuming the first projector 112(1) is the reference projector 118, the geometric mapping of the second projector 112(2) to the first (reference) projector 112(1) can be determined as shown in the following Equation XIII:

F₂=T₂T₁⁻¹ Equation XIII
where:
   F₂=operator that maps a low-resolution sub-frame 110 of the second projector 112(2) to the
   first (reference) projector 112(1);
   T₁=geometric mapping between the first projector 112(1) and the camera 122; and
   T₂=geometric mapping between the second projector 112(2) and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

One form of the multiple color projector embodiments provides an projection system 12B with multiple overlapped low-resolution projectors 112 coupled with an efficient real-time (e.g., video rates) image processing algorithm for generating sub-frames 110. Multiple low-resolution, low-cost projectors 112 may be used to produce high resolution images 114 at high lumen levels but at lower cost than existing high-resolution projection systems, such as a single, high-resolution, high-output projector. One form of the multiple color projector embodiments provides a scalable projection system 12B that can provide virtually any desired resolution and brightness by adding any desired number of component projectors 112 to the projection system 12B.

In some existing display systems, multiple low-resolution images are displayed with temporal and sub-pixel spatial offsets to enhance resolution. There are some important differences between these existing systems and the multiple color projector embodiments. For example, in one embodiment of the present invention, there is no need for circuitry to offset the projected sub-frames 110 temporally. In one form of the invention, the sub-frames 110 from the component projectors 112 are projected “in-sync”. As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the multiple color projector embodiments, the signal processing model that is used to generate optimal sub-frames 110 takes into account relative geometric distortion among the component sub-frames 110, and is robust to minor calibration errors and noise.

It can be difficult to accurately align projectors into a desired configuration. In one form of the multiple color projector embodiments, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the multiple color projector embodiments utilizes an optimal real-time sub-frame generation algorithm that explicitly accounts for arbitrary relative geometric distortion (not limited to homographies) between the component projectors 112, including distortions that occur due to a display surface 116 that is non-planar or has surface non-uniformities. One form of the multiple color projector embodiments generates sub-frames 110 based on a geometric relationship between a hypothetical high-resolution reference projector 118 at any arbitrary location and each of the actual low-resolution projectors 112, which may also be positioned at any arbitrary location.

In one embodiment, projection system 12B is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, projection system 12B may be combined or used with other display systems or display techniques, such as tiled displays.

B. Single Color Projectors

In one embodiment, each projector 112 in projection system 12B projects a single color.

i. Multi-Primary Image Display Systems

With multi-primary image display systems 10 (described in Section I(B) above), the combination of all projectors 112 in projection system 12B display at least four different display primaries 24.

FIG. 10 is a diagram illustrating four sets of display primaries 115D, 115E, 115F, and 115G according to one embodiment. Set 115D includes a red display primary 24, set 115E includes a green display primary 24, set 115F includes a blue display primary 24, and set 115G includes a yellow display primary 24. Sets 115D, 115E, 115F, and 115G may each be implemented as any suitable light filtering devices in projectors 112.

In one embodiment, a first subset of projectors 112(1)-112(j) each include set 115D, a second subset of projectors 112(j+1)-112(k) each include set 115E, a third subset of projectors 112(k+1)-112(l) each include set 115F, and a fourth subset of projectors 112(l+1)-112(N) each include set 115G, where j, k, and l are each integers between 1 and (N−1) inclusive and j<k<1. Each subset of projectors 112 includes one or more projectors 112.

In this embodiment, projection system 12B is divided into four subsets of projectors 112 where the subsets combine to project four display primaries: red, green, blue, and yellow. In other embodiments, projectors 112 may be further divided into additional subsets where each subset of projectors 112 includes a different set of display primaries and each set of display primaries differs from the other sets of display primaries.

For the embodiment of FIG. 10, sub-frame generator 108 (FIG. 6) generates sub-frames 110 as single-color sub-frames as described below with reference to FIG. 11. For example, sub-frames 110(1) may be red sub-frames for projector 112(1), sub-frames 110(2) may be green sub-frames for projector 112(2), sub-frames 110(3) may be blue sub-frames for projector 112(3), and sub-frames 110(4) may be yellow sub-frames for projector 112(4).

ii. Standard Primary Image Display Systems

With standard primary image display systems 10 (described in Section I(B) above), each projector 112 in projection system 12B displays a single display primaries (e.g., a red, a green, or a blue primary). Sub-frame generator 108 (FIG. 6) generates sub-frames 110 with the colors for each projector 112 as described below with reference to FIG. 11.

iii. Sub-Frame Generation for Single Color Projectors

Naïve overlapped projection of different colored sub-frames 110 by different projectors 112 can lead to significant color artifacts at the edges due to misregistration among the colors. In the embodiments of FIG. 11, sub-frame generator 108 determines the single-color sub-frames 110 to be projected by each projector 112 so that the visibility of color artifacts is minimized.

FIG. 11 is a diagram illustrating a model of an image formation process according to one embodiment of the present invention. The sub-frames 110 are represented in the model by Yᵢₖ, where “k” is an index for identifying individual sub-frames 110, and “i” is an index for identifying color planes. Two of the sixteen pixels of the sub-frame 110 shown in FIG. 11 are highlighted, and identified by reference numbers 400A-1 and 400B-1. The sub-frames 110 (Yᵢₖ) are represented on a hypothetical high-resolution grid by up-sampling (represented by Dᵢ^{T}) to create up-sampled image 401. The up-sampled image 401 is filtered with an interpolating filter (represented by Hᵢ) to create a high-resolution image 402 (Zᵢₖ) with “chunky pixels”. This relationship is expressed in the following Equation XIV:

Zᵢₖ=HᵢDᵢ^{T}Yᵢₖ Equation XIV
where:
   k=index for identifying individual sub-frames 110;
   i=index for identifying color planes;
   Zᵢₖ=kth low-resolution sub-frame 110 in the ith color plane on a hypothetical high-resolution grid;
   Hᵢ=Interpolating filter for low-resolution sub-frames 110 in the ith color plane;
   Dᵢ^{T}=up-sampling matrix for sub-frames 110 in the ith color plane; and

Yᵢₖ=kth low-resolution sub-frame 110 in the ith color plane.

The low-resolution sub-frame pixel data (Yᵢₖ) is expanded with the up-sampling matrix (Dᵢ^{T}) so that the sub-frames 110 (Yᵢₖ) can be represented on a high-resolution grid. The interpolating filter (Hᵢ) fills in the missing pixel data produced by up-sampling. In the embodiment shown in FIG. 11, pixel 400A-1 from the original sub-frame 110 (Yᵢₖ) corresponds to four pixels 400A-2 in the high-resolution image 402 (Zᵢₖ), and pixel 400B-1 from the original sub-frame 110 (Yᵢₖ) corresponds to four pixels 400B-2 in the high-resolution image 402 (Zᵢₖ). The resulting image 402 (Zᵢₖ) in Equation XIV models the output of the projectors 112 if there was no relative distortion or noise in the projection process. Relative geometric distortion between the projected component sub-frames 110 results due to the different optical paths and locations of the component projectors 112. A geometric transformation is modeled with the operator, Fᵢₖ, which maps coordinates in the frame buffer 113 of a projector 112 to the frame buffer 120 of the reference projector 118 (FIG. 6) with sub-pixel accuracy, to generate a warped image 404 (Z_{ref}). In one embodiment, Fᵢₖ is linear with respect to pixel intensities, but is non-linear with respect to the coordinate transformations. As shown in FIG. 11, the four pixels 400A-2 in image 402 are mapped to the three pixels 400A-3 in image 404, and the four pixels 400B-2 in image 402 are mapped to the four pixels 400B-3 in image 404.

In one embodiment, the geometric mapping (Fᵢₖ) is a floating-point mapping, but the destinations in the mapping are on an integer grid in image 404. Thus, it is possible for multiple pixels in image 402 to be mapped to the same pixel location in image 404, resulting in missing pixels in image 404. To avoid this situation, in one form of the present invention, during the forward mapping (Fᵢₖ), the inverse mapping (Fᵢₖ⁻¹) is also utilized as indicated at 405 in FIG. 11. Each destination pixel in image 404 is back projected (i.e., Fᵢₖ⁻¹) to find the corresponding location in image 402. For the embodiment shown in FIG. 11, the location in image 402 corresponding to the upper-left pixel of the pixels 400A-3 in image 404 is the location at the upper-left corner of the group of pixels 400A-2. In one form of the invention, the values for the pixels neighboring the identified location in image 402 are combined (e.g., averaged) to form the value for the corresponding pixel in image 404. Thus, for the example shown in FIG. 11, the value for the upper-left pixel in the group of pixels 400A-3 in image 404 is determined by averaging the values for the four pixels within the frame 403 in image 402.

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 402 is mapped to a floating point location in image 404, some of the image data for the pixel is essentially scattered to multiple pixels neighboring the floating point location in image 404. Thus, each pixel in image 404 may receive contributions from multiple pixels in image 402, and each pixel in image 404 is normalized based on the number of contributions it receives.

A superposition/summation of such warped images 404 from all of the component projectors 112 in a given color plane forms a hypothetical or simulated high-resolution image (X-hatᵢ) for that color plane in the reference projector frame buffer 120, as represented in the following Equation XV:

$${\hat{X}}_{i} = {\sum }_{k} {F}_{ik} {Z}_{ik} \qquad Equation XV$$

where:
   k=index for identifying individual sub-frames 110;
   i=index for identifying color planes;
   X-hatᵢ=hypothetical or simulated high-resolution image for the ith color plane in the reference projector frame buffer 120;
   Fᵢₖ=operator that maps the kth low-resolution sub-frame 110 in the ith color plane on a hypothetical high-resolution grid to the reference projector frame buffer 120; and
   Zᵢₖ=kth low-resolution sub-frame 110 in the ith color plane on a hypothetical high-resolution grid, as defined in Equation XIV.

A hypothetical or simulated image 406 (X-hat) is represented by the following Equation XVI:

\hat{X}=[\hat{X}₁\hat{X}₂ . . . \hat{X}_{N}]^{T} Equation XVI
where:
   X-hat=hypothetical or simulated high-resolution image in the reference projector frame buffer 120;
   X-hat₁=hypothetical or simulated high-resolution image for the first color plane in the reference projector frame buffer 120, as defined in Equation XV;
   X-hat₂=hypothetical or simulated high-resolution image for the second color plane in the reference projector frame buffer 120, as defined in Equation XV;
   X-hat_{N}=hypothetical or simulated high-resolution image for the Nth color plane in the reference projector frame buffer 120, as defined in Equation XV; and
   N=number of color planes.

If the simulated high-resolution image 406 (X-hat) in the reference projector frame buffer 120 is identical to a given (desired) high-resolution image 408 (X), the system of component low-resolution projectors 112 would be equivalent to a hypothetical high-resolution projector placed at the same location as the reference projector 118 and sharing its optical path. In one embodiment, the desired high-resolution images 408 are the high-resolution image frames 106 (FIG. 6) received by sub-frame generator 108.

In one embodiment, the deviation of the simulated high-resolution image 406 (X-hat) from the desired high-resolution image 408 (X) is modeled as shown in the following Equation XVII:

X=\hat{X}+η Equation XVII
where:
   X=desired high-resolution frame 408;
   X-hat=hypothetical or simulated high-resolution frame 406 in the reference projector frame buffer 120; and
   η=error or noise term.

As shown in Equation XVII, the desired high-resolution image 408 (X) is defined as the simulated high-resolution image 406 (X-hat) plus η, which in one embodiment represents zero mean white Gaussian noise.

The solution for the optimal sub-frame data (Yᵢₖ*) for the sub-frames 110 is formulated as the optimization given in the following Equation XVIII:

$${Y}_{ik}^{*} = {arg max}_{{Y}_{ik}} P ( \hat{X} \vert X ) \qquad Equation XVIII$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   X-hat=hypothetical or simulated high-resolution frame 406 in the reference projector frame buffer 120, as defined in Equation XVI;
   X=desired high-resolution frame 408; and
   P(X-hat|X)=probability of X-hat given X.

Thus, as indicated by Equation XVIII, the goal of the optimization is to determine the sub-frame values (Yᵢₖ) that maximize the probability of X-hat given X. Given a desired high-resolution image 408 (X) to be projected, sub-frame generator 108 (FIG. 6) determines the component sub-frames 110 that maximize the probability that the simulated high-resolution image 406 (X-hat) is the same as or matches the “true” high-resolution image 408 (X).

Using Bayes rule, the probability P(X-hat|X) in Equation XVIII can be written as shown in the following Equation XIX:

$$P ( \hat{X} \vert X ) = \frac{P ( X \vert \hat{X} ) P ( \hat{X} )}{P ( X )} \qquad Equation XIX$$

where:
   X-hat=hypothetical or simulated high-resolution frame 406 in the reference projector frame buffer 120, as defined in Equation XVI;
   X=desired high-resolution frame 408;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation XIX is a known constant. If X-hat is given, then, referring to Equation XVII, X depends only on the noise term, η, which is Gaussian. Thus, the term P(X|X-hat) in Equation XIX will have a Gaussian form as shown in the following Equation XX:

$$P ( X \vert \hat{X} ) = \frac{1}{C} {e}^{- {\sum }_{i} \frac{( {‖ {X}_{i} - {\hat{X}}_{i} ‖}^{2} )}{2 {σ}_{i}^{2}}} \qquad Equation XX$$

where:
   X-hat=hypothetical or simulated high-resolution frame 406 in the reference projector frame buffer 120, as defined in Equation XVI;
   X=desired high-resolution frame 408;
   P(X|X-hat)=probability of X given X-hat;
   C=normalization constant;
   i=index for identifying color planes;
   Xᵢ=ith color plane of the desired high-resolution frame 408;
   X-hatᵢ=hypothetical or simulated high-resolution image for the ith color plane in the reference projector frame buffer 120, as defined in Equation II; and
   σᵢ=variance of the noise term, η, for the ith color plane.

To provide a solution that is robust to minor calibration errors and noise, a “smoothness” requirement is imposed on X-hat. In other words, it is assumed that good simulated images 406 have certain properties. For example, for most good color images, the luminance and chrominance derivatives are related by a certain value. In one embodiment, a smoothness requirement is imposed on the luminance and chrominance of the X-hat image based on a “Hel-Or” color prior model, which is a conventional color model known to those of ordinary skill in the art. The smoothness requirement according to one embodiment is expressed in terms of a desired probability distribution for X-hat given by the following Equation XXI:

$$P ( \hat{X} ) = \frac{1}{Z ( α , β )} {e}^{- \{ {α}^{2} ( {‖ ∇ {\hat{C}}_{1} ‖}^{2} + {‖ ∇ {\hat{C}}_{2} ‖}^{2} ) + {β}^{2} ( {‖ ∇ \hat{L} ‖}^{2} ) \}} \qquad Equation XXI$$

where:
   P(X-hat)=prior probability of X-hat;
   α and β=smoothing constants;
   Z(α, β)=normalization function;
   ∇=gradient operator; and
   C-hat₁=first chrominance channel of X-hat;
   C-hat₂=second chrominance channel of X-hat;
   and
   L-hat=luminance of X-hat.

In another embodiment of the invention, the smoothness requirement is based on a prior Laplacian model, and is expressed in terms of a probability distribution for X-hat given by the following Equation XXII:

$$P ( \hat{X} ) = \frac{1}{Z ( α , β )} {e}^{- \{ α ( \vert ∇ {\hat{C}}_{1} \vert + \vert ∇ {\hat{C}}_{2} \vert ) + β ( \vert ∇ \hat{L} \vert ) \}} \qquad Equation XXII$$

where:
   P(X-hat)=prior probability of X-hat;
   α and β=smoothing constants;
   Z(α, β)=normalization function;
   ∇=gradient operator; and
   C-hat₁=first chrominance channel of X-hat;
   C-hat₂=second chrominance channel of X-hat;
   and
   L-hat=luminance of X-hat.

The following discussion assumes that the probability distribution given in Equation XXI, rather than Equation XXII, is being used. As will be understood by persons of ordinary skill in the art, a similar procedure would be followed if Equation XXII were used. Inserting the probability distributions from Equations VII and VIII into Equation XIX, and inserting the result into Equation XVIII, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation XVIII is transformed into a function minimization problem, as shown in the following Equation XXIII:

$$\begin{matrix}\begin{matrix}{Y}_{ik}^{*} {arg min}_{{Y}_{ik}} {\sum }_{i = 1}^{N} {‖ {X}_{i} - {\hat{X}}_{i} ‖}^{2} + \\ {α}^{2} \{ {‖ ∇ ( {\sum }_{i = 1}^{N} {T}_{{C}_{1} i} {\hat{X}}_{i} ) ‖}^{2} + {‖ ∇ ( {\sum }_{i = 1}^{N} {T}_{{C}_{2} i} {\hat{X}}_{i} ) ‖}^{2} \} +\end{matrix} \\ {β}^{2} {‖ ∇ ( {\sum }_{i = 1}^{N} {T}_{Li} {\hat{X}}_{i} ) ‖}^{2}\end{matrix} \qquad Equation XXIII$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   N=number of color planes;
   Xᵢ=ith color plane of the desired high-resolution frame 408;
   X-hatᵢ=hypothetical or simulated high-resolution image for the ith color plane in the reference projector frame buffer 120, as defined in Equation XV;
   α and β=smoothing constants;
   ∇=gradient operator;
   T_{Cli}=ith element in the second row in a color transformation matrix, T, for transforming the first chrominance channel of X-hat;
   T_{C2i}=ith element in the third row in a color transformation matrix, T, for transforming the second chrominance channel of X-hat; and
   T_{Li}=ith element in the first row in a color transformation matrix, T, for transforming the luminance of X-hat.

The function minimization problem given in Equation XXIII is solved by substituting the definition of X-hatᵢ from Equation XV into Equation XXIII and taking the derivative with respect to Yᵢₖ, which results in an iterative algorithm given by the following Equation XXIV:

$${Y}_{ik}^{( n + 1 )} = {Y}_{ik}^{( n )} - Θ \{ {D}_{i} {F}_{ik}^{T} {H}_{i}^{T} [ ( {\hat{X}}_{i}^{( n )} - {X}_{i} ) + {α}^{2} {∇}^{2} ( {T}_{{C}_{1} i} {\sum }_{j = 1}^{N} {T}_{{C}_{1} j} {\hat{X}}_{j}^{( n )} + {T}_{{C}_{2} i} {\sum }_{j = 1}^{N} {T}_{{C}_{2} j} {\hat{X}}_{j}^{( n )} ) … + {β}^{2} {∇}^{2} {T}_{Li} {\sum }_{j = 1}^{N} {T}_{Lj} {\hat{X}}_{j}^{( n )} ] \} \qquad Equation XXIV$$

where:
   k=index for identifying individual sub-frames 110;
   i and j=indices for identifying color planes;
   n=index for identifying iterations;
   Yᵢₖ⁽ⁿ⁺¹⁾=kth low-resolution sub-frame 110 in the ith color plane for iteration number n+1;
   Yᵢₖ⁽ⁿ⁾=kth low-resolution sub-frame 110 in the ith color plane for iteration number n;
   Θ=momentum parameter indicating the fraction of error to be incorporated at each iteration;
   Dᵢ=down-sampling matrix for the ith color plane;
   Hᵢ^{T}=Transpose of interpolating filter, Hᵢ, from Equation XIV (in the image domain, Hᵢ^{T} is a flipped version of Hᵢ);
   Fᵢₖ^{T}=Transpose of operator, Fᵢₖ, from Equation XV (in the image domain, Fᵢₖ^{T} is the inverse of the warp denoted by Fᵢₖ);
   X-hatᵢ⁽ⁿ⁾=hypothetical or simulated high-resolution image for the ith color plane in the reference projector frame buffer 120, as defined in Equation XV, for iteration number n;
   Xᵢ=ith color plane of the desired high-resolution frame 408;
   α and β=smoothing constants;
   ∇²=Laplacian operator;
   T_{Cli}=ith element in the second row in a color transformation matrix, T, for transforming the first chrominance channel of X-hat;
   T_{C2i}=ith element in the third row in a color transformation matrix, T, for transforming the second chrominance channel of X-hat;
   T_{Li}=ith element in the first row in a color transformation matrix, T, for transforming the luminance of X-hat;
   X-hatⱼ⁽ⁿ⁾=hypothetical or simulated high-resolution image for the jth color plane in the reference projector frame buffer 120, as defined in Equation XV, for iteration number n;
   T_{Clj}=jth element in the second row in a color transformation matrix, T, for transforming the first chrominance channel of X-hat;
   T_{C2j}=jth element in the third row in a color transformation matrix, T, for transforming the second chrominance channel of X-hat;
   T_{Lj}=jth element in the first row in a color transformation matrix, T, for transforming the luminance of X-hat; and
   N=number of color planes.

Equation XXIV may be intuitively understood as an iterative process of computing an error in the reference projector 118 coordinate system and projecting it back onto the sub-frame data. In one embodiment, sub-frame generator 108 (FIG. 6) is configured to generate sub-frames 110 in real-time using Equation XXIV. The generated sub-frames 110 are optimal in one embodiment because they maximize the probability that the simulated high-resolution image 406 (X-hat) is the same as the desired high-resolution image 408 (A), and they minimize the error between the simulated high-resolution image 406 and the desired high-resolution image 408. Equation XXIV can be implemented very efficiently with conventional image processing operations (e.g., transformations, down-sampling, and filtering). The iterative algorithm given by Equation XXIV converges rapidly in a few iterations and is very efficient in terms of memory and computation (e.g., a single iteration uses two rows in memory; and multiple iterations may also be rolled into a single step). The iterative algorithm given by Equation XXIV is suitable for real-time implementation, and may be used to generate optimal sub-frames 110 at video rates, for example.

To begin the iterative algorithm defined in Equation XXIV, an initial guess, Yᵢₖ⁽⁰⁾, for the sub-frames 110 is determined. In one embodiment, the initial guess for the sub-frames 110 is determined by texture mapping the desired high-resolution frame 408 onto the sub-frames 110. In one form of the invention, the initial guess is determined from the following Equation XXV:

Yᵢₖ⁽⁰⁾=DᵢBᵢFᵢₖ^{T}Xᵢ Equation XXV
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Bᵢ=interpolation filter for the ith color plane;
   Fᵢₖ^{T}=Transpose of operator, Fᵢₖ, from Equation XV (in the image domain, Fᵢₖ^{T} is the inverse of the warp denoted by Fᵢₖ); and
   Xᵢ=ith color plane of the desired high-resolution frame 408.

Thus, as indicated by Equation XXV, the initial guess (Yᵢₖ⁽⁰⁾) is determined by performing a geometric transformation (Fᵢₖ^{T}) on the ith color plane of the desired high-resolution frame 408 (Xᵢ), and filtering (Bᵢ) and down-sampling (Dᵢ) the result. The particular combination of neighboring pixels from the desired high-resolution frame 408 that are used in generating the initial guess (Yᵢₖ⁽⁰⁾) will depend on the selected filter kernel for the interpolation filter (Bᵢ).

In another form of the invention, the initial guess, Yᵢₖ⁽⁰⁾, for the sub-frames 110 is determined from the following Equation XXVI:

Yᵢₖ⁽⁰⁾=DᵢFᵢₖ^{T}Xᵢ Equation XXVI
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Fᵢₖ^{T}=Transpose of operator, Fᵢₖ, from Equation XV (in the image domain, Fᵢₖ is the inverse of the warp denoted by Fᵢₖ); and
   Xᵢ=ith color plane of the desired high-resolution frame 408.

Equation XXVI is the same as Equation XXV, except that the interpolation filter (Bₖ) is not used.

Several techniques are available to determine the geometric mapping (Fᵢₖ) between each projector 112 and the reference projector 118, including manually establishing the mappings, or using camera 122 and calibration unit 124 (FIG. 6) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a projection system 12B with two projectors 112(1) and 112(2), assuming the first projector 112(1) is the reference projector 118, the geometric mapping of the second projector 112(2) to the first (reference) projector 112(1) can be determined as shown in the following Equation XXVII:

F₂=T₂T₁⁻¹ Equation XXVII
where:
   F₂=operator that maps a low-resolution sub-frame 110 of the second projector 112(2) to the
   first (reference) projector 112(1);
   T₁=geometric mapping between the first projector 112(1) and the camera 122; and
   T₂=geometric mapping between the second projector 112(2) and the camera 122.

In one embodiment, the geometric mappings (Fᵢₖ) are determined once by calibration unit 124, and provided to sub-frame generator 108. In another embodiment, calibration unit 124 continually determines (e.g., once per frame 106) the geometric mappings (Fᵢₖ), and continually provides updated values for the mappings to sub-frame generator 108.

One form of the single color projector embodiments provides an projection system 12B with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable projection system 12B that can provide virtually any desired resolution, brightness, and color, by adding any desired number of component projectors 112 to the projection system 12B.

In some existing display systems, multiple low-resolution images are displayed with temporal and sub-pixel spatial offsets to enhance resolution. There are some important differences between these existing systems and the single color projector embodiments. For example, in one embodiment of the present invention, there is no need for circuitry to offset the projected sub-frames 110 temporally. In one form of the invention, the sub-frames 110 from the component projectors 112 are projected “in-sync”. As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the single color projector embodiments, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the single color projector embodiments, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a display surface 116 that is non-planar or has surface non-uniformities. One form of the single color projector embodiments generates sub-frames 110 based on a geometric relationship between a hypothetical high-resolution reference projector 118 at any arbitrary location and each of the actual low-resolution projectors 112, which may also be positioned at any arbitrary location.

One form of the single color projector embodiments provides a projection system 12B with multiple overlapped low-resolution projectors 112, with each projector 112 projecting a different colorant to compose a full color high-resolution image 114 on the screen 116 with minimal color artifacts due to the overlapped projection. By imposing a color-prior model via a Bayesian approach as is done in one embodiment of the invention, the generated solution for determining sub-frame values minimizes color aliasing artifacts and is robust to small modeling errors.

Using multiple off the shelf projectors 112 in projection system 12B allows for high resolution. However, if the projectors 112 include a color wheel, which is common in existing projectors, the projection system 12B may suffer from light loss, sequential color artifacts, poor color fidelity, reduced bit-depth, and a significant tradeoff in bit depth to add new colors. One form of the present invention eliminates the need for a color wheel, and uses in its place, a different color filter for each projector 112 as shown in FIG. 10. Thus, in one embodiment, projectors 112 each project different single-color images. By not using a color wheel, segment loss at the color wheel is eliminated, which could be up to a 20% loss in efficiency in single chip projectors. One forn of the single color projector embodiments increases perceived resolution, eliminates sequential color artifacts, improves color fidelity since no spatial or temporal dither is required, provides a high bit-depth per color, and allows for high-fidelity color.

Projection system 12B is also very efficient from a processing perspective since, in one embodiment, each projector 112 only processes one color plane. For example, each projector 112 reads and renders only one-fourth (for RGBY) of the full color data in one embodiment.

In one embodiment, projection system 12B is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, projection system 12B may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An image display system comprising:
an image generator configured to generate display information for at least four display primaries by applying distortion information to an input signal, the distortion information configured to compensate for variations in human cone responses; and
a display device including the at least four display primaries and configured to display a first image with the at least four display primaries using the display information such that distortion from the distortion information appears in a second image captured by an image capture device to include the first image and such that substantially all human observers do not see the distortion in the first image.

2. The image display system of claim 1 wherein the distortion information is derived from a database that includes sufficient human cone response information to account for variations in human cone responses.

3. The image display system of claim 2 wherein the human cone response information is associated with a large number of human observers.

4. The image display system of claim 1 wherein the display device includes a projector configured to display at least four display colors that correspond to the at least four display primaries.

5. The image display system of claim 1 wherein the display device includes a sub-frame generator and first and second projectors, wherein the sub-frame generator is configured to generate first and second sub-frames corresponding to the first image, and wherein the first and the second projectors are configured to simultaneously project the first and the second sub-frames, respectively, onto first and second positions, respectively, that at least partially overlap on a display surface.

6. The image display system of claim 5 wherein the first projector includes a first subset of the at least four display primaries, wherein the second projector includes a second subset of the at least four display primaries, and wherein the first subset differs from the second subset.

7. The image display system of claim 5 wherein the first and the second projectors each include each of the at least four display primaries.

8. The image display system of claim 5 wherein the display device includes third and fourth projectors, wherein the sub-frame generator is configured to generate third and fourth sub-frames corresponding to the first image, and wherein the first, the second, the third, and the fourth projectors are configured to simultaneously project the first, the second, the third, and the fourth sub-frames, respectively, onto the first, the second, third, and fourth positions, respectively, that at least partially overlap on the display surface using a first one, a second one, a third one, and a fourth one of the at least four display primaries, respectively.

9. The image display system of claim 1 wherein the image generator is configured to apply the distortion information to the input signal using at least one gain factor.

10. A method comprising:
receiving an image frame; and
forming a set of at least four display primary values for each of a set of pixel locations in the image frame to maximize a perceptual difference between a first image projected onto a display surface using the sets of display primary values and a second image captured by an image capture device to include the first image while compensating for human cone response variations.

11. The method of claim 10 wherein the set of pixel locations in the image frame includes all pixel locations in the image frame.

12. The method of claim 10 wherein the set of pixel locations in the image frame includes less than all pixel locations in the image frame.

13. The method of claim 10 wherein the set of pixel locations corresponds to at least one selected region in the image frame.

14. A method comprising:
receiving an image frame; and
for each of a set of pixel locations in the image frame, remapping a pixel value from a first color to a second color using distortion information that identifies the first color and the second color as minimally distinct when viewed by a human observer in a first image that is displayed using the remapped pixel values and maximally distinct when captured in a second image by an image capture device to include the first image.

15. The method of claim 14 further comprising:
displaying the first image using the remapped pixel values.

16. The method of claim 14 further comprising:
projecting the first image onto a display surface using at least two sub-frames that include the remapped pixel values.

17. The method of claim 14 wherein the distortion information causes a minimum amount of distortion to be seen by the human observer in the first image and a maximum amount of distortion to appear in the second image that is captured by the image capture device.

18. The method of claim 14 wherein the set of pixel locations in the image frame includes all pixel locations in the image frame.

19. The method of claim 14 wherein the set of pixel locations in the image frame includes less than all pixel locations in the image frame.

20. The method of claim 14 wherein the set of pixel locations corresponds to at least one selected region in the image frame.
